(19) United States
(12) Patent Application Publication
(10) Pub. No.: US 2026/0030146 A1
(43) Pub. Date: Jan. 29, 2026

(54) SYSTEMS AND METHODS FOR INTEGRATION THROUGH ELECTRONIC INFORMATION EXCHANGE PLATFORM

(71) Applicant: OPEN TEXT HOLDINGS, INC., Menlo Park, CA (US)

(72) Inventor: Walter Hughes Lindsay, Phoenix, AZ (US)

(21) Appl. No.: 18/787,829

(22) Filed: Jul. 29, 2024

(51) Int. Cl. G06F 11/36; G06F 8/41

(52) U.S. Cl. CPC G06F 11/3688; G06F 8/433; G06F 11/3676

(57) ABSTRACT

An integration system presents, in a test mode of an instance of an electronic information exchange platform, processing steps of a workflow to be implemented, the workflow involving entity systems, the processing steps corresponding to tasks specified in a task model. Through an enhanced user interface (UI), a scope of the processing steps for testing is received. One of the processing steps has a dependency on a predecessor in the workflow. Through the enhanced UI, an instruction to run a test on the scope of the processing steps is received. The dependency is held without generating an error message and the test is allowed to proceed. Responsive to failure of the test, the integration system determines variations of tasks in the scope, makes recommendations based on the variations of tasks in the scope, and presents, through the enhanced UI, the recommendations with documentation describing each of the recommendations.

### TECHNICAL FIELD

This disclosure relates generally to electronic information exchange in a distributed computing environment. More particularly, this disclosure relates to self-service/self-testing systems, methods, and computer program products that enable entities to perform self-service/self-testing in setting up, extending, maintain, and operating heterogenous integrations over an electronic information exchange platform.

### BACKGROUND OF THE RELATED ART

Today, enterprises and entities alike recognize the tremendous cost savings by exchanging business documents with their trading partners via an electronic communication method referred to as the Electronic Data Interchange (EDI). Enterprises exchange similar information using application programming interfaces (APIs). An electronic information exchange platform may provide various services to networked enterprise systems so that documents such as invoices, purchase orders, etc. can be exchanged over a network, for instance, using EDI. Skilled artisans appreciate that such an electronic information exchange platform has the necessary resources (e.g., hardware, software, personnel, etc.) to provide services that enable the real-time flow or exchange of information electronically in a network environment.

Over time, the number and kinds of services continue to grow, as well as the number of customer (client) systems that the electronic information exchange platform needs to support at any given time. Given the vast amounts of data involved in the real-time flow or exchange of information electronically in a network environment, scaling up the electronic information exchange platform so to continuously provide various services to an increasing number of entity systems in a secure, fast, and reliable manner can be technically challenging and cost prohibitive.

One reason that scaling up an electronic information exchange platform can be technically challenging and cost prohibitive is the need for complex and time consuming manual coding and configuration for each system-to-system integration that involves the electronic information exchange platform. Each entity system that wants to connect to the electronic information exchange platform may have requirements for different services (which are managed and provided by the electronic information exchange platform) and these requirements may differ from entity system to entity system. This means that program instructions, configuration settings, rules, algorithms, etc. that work for a particular integration may not be useful for another integration.

Complicating the matter is that these entity systems can be very diverse and may be located in various geographical and/or jurisdictional locations, with disparate formats/system/application/device requirements. Further, depending upon the roles of these client systems (e.g., buyers, sellers, suppliers, etc.), they may have very different source-based, destination-based, location-based, role-based, and/or compliance-based requirements for electronically exchanging information. Consequently, setting up, extending, maintaining, and operating integrations over an electronic information exchange platform can be extremely complicated and technically challenging.

### SUMMARY OF THE DISCLOSURE

A goal of this disclosure is to provide an artificial intelligence (AI)-assisted solution that allows an authorized user to perform self-service/self-testing in setting up, extending, maintain, and operating system-to-system integrations over an electronic information exchange platform. The AI-assisted solution includes a reusable integration component, referred to as a digital avatar, that can integrate an entity with one or more entities, even if these entities have varying data and processing requirements. The digital avatar is adapted to guide the entity to follow the varying data and process conventions of other entities so as to achieve a successful integration without much manual coding.

In some embodiments, an integration system is adapted to present, in a test mode of an instance of an electronic information exchange platform, processing steps of a workflow to be implemented on the instance of the electronic information exchange platform, the workflow involving entity systems, the processing steps corresponding to tasks specified in a task model, the integration system having an enhanced user interface (UI). In some embodiments, a least a portion of the processing steps are performed by avatars of the entity systems, the avatars operated by the integration system. In some embodiments, the integration system includes a testing framework and the task model can be part of the testing framework.

In some embodiments, through the enhanced UI, the integration system receives a scope of the processing steps for testing. One of the processing steps may have a dependency on a predecessor in the workflow. Through the enhanced UI, the integration system receives an instruction to run a test on the scope of the processing steps. The integration system is adapted to hold (e.g., flag) any dependency error and allow the test to continue. Responsive to failure of the test, the integration system determines variations of tasks in the scope, makes recommendations based on the variations of tasks in the scope, and presents, through the enhanced UI, the recommendations with documentation describing each of the recommendations.

In some embodiments, the integration system may present a configuration of the test through the enhanced UI. Through the enhanced UI, the integration system may receive a change to the configuration and, correspondingly, updates a configuration file to reflect the change to the configuration.

In some embodiments, the integration system may receive, from the same user or different users of an entity system, configurations of tests of the workflow or a portion thereof. The integration system is adapted to aggregate the configurations in the configuration file.

In some embodiments, the integration system may receive a confirmation from a user of the entity system that a system-wide test of the workflow is successful. Subsequently, the integration may start to monitor communications between the entity systems in a production mode.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatical representation of a networked computing environment where an electronic information exchange platform operates to provide services to a plurality of operating units.

FIG. 2 depicts a diagrammatical representation of an avatar that is part of an integration system operating on an electronic information exchange platform.

FIG. 3 depicts a unidirectional process flow for setting up an integration so as to move data from one entity to another through automation implemented on an electronic information exchange platform.

FIGS. 4A-4C together illustrate a multi-directional process flow with decision points and disjointed tasks.

FIG. 5 is a diagram that illustrates an example of an operating unit and its trading partner communicating with one another through their respective avatars in an integration system, according to some embodiments disclosed herein.

FIG. 6 is a diagrammatic representation of design time components and runtime components of an example of an integration system according to some embodiments disclosed herein.

FIG. 7 provides a summary view of an example of a workflow involving a plurality of processing steps.

FIGS. 8A-8B diagrammatically illustrate how a self-service/self-testing tool and avatars running on an electronic information exchange platform can be utilized to configure and test an integration so as to reach a milestone according to some embodiments disclosed herein.

FIG. 9 is a flow chart that illustrates an example of a method performed by an integration system implementing a self-service/self-testing tool according to some embodiments disclosed herein.

FIG. 10 is a flow chart that illustrates an example of a computer-implemented method for self-testing an integration according to some embodiments disclosed herein.

FIG. 11 depicts a diagrammatical representation of a system for testing a configuration resulting from a set of tasks on a transactional system according to some embodiments disclosed herein.

FIG. 12 illustrates an exemplary architecture for network computing environment for implementing an embodiment disclosed herein.

### DETAILED DESCRIPTION

### Glossary

Integration—moving data through automation, e.g., moving data from one entity to another with one or more applications. The invention provides a reusable integration component that can integrate an entity with one or more entities that have varying data and processing requirements, such that a first entity can follow the varying data and process conventions of other entities. For instance, in a business-to-business (B2B) integration, typically a seller (the first entity) needs to conform to the requirements of buyers (the other entities).

Reusable integration component—also referred to herein as a “kit” or a “digital avatar” (“avatar”). An avatar can be created by an integration system for an electronic information exchange platform. An example of a suitable integration system is described in U.S. Patent Application Publication No. 2023/0359968, entitled “INTELLIGENT INTEGRATION SYSTEMS AND METHODS WITH DIGITAL AVATARS,” which is incorporated by reference herein. In this disclosure, an avatar represents a computing system of an enterprise (e.g., a buyer, a seller, a supplier, a retailer, an intermediary, etc.) within a computing environment where the integration system presides over an integration between entities. Avatars do not represent humans and are not controlled by humans. An avatar for an entity can be adapted to variations in the entity. For instance, users of an application such as an enterprise resource planning (ERP) system very often customize the ERP system, and this customization can affect the data and processes of the ERP system. An avatar can be adapted to accommodate such a customization.

Operating unit—in this disclosure, an operating unit, also referred to herein as an “entity,” may represent a company, a corporation, an enterprise, or a division thereof.

Transaction—an exchange of business-meaningful data between actors over the electronic information exchange platform, using canonical definitions of transactions to capture both standard and variant behaviors of the actors.

Actor—an entity or an avatar. An actor involves software and humans and partakes in workflows.

Entity system—an ERP system, a trading partner, a data warehouse, an analytic system, or the like that can accept or produce data, and that follows its own rules (e.g., workflows). The Integration System exchanges data and interoperates with entity systems. Entity systems also have other interactions, such as a user entering data into a UI of an entity system, or providing APIs for automated data exchange that does not occur through an integration.

Workflow—an exchange of transactions so that two or more parties can transact and do business through their respective entity systems. A workflow defines a general pattern; a “workflow instance” results when a specific order triggers the exchange of a set of other specific transaction instances, i.e., how a runtime platform or an entity system organizes processing steps. A workflow can include branching, error-handling, data exchange with external systems, etc. A workflow is configurable. An end-to-end workflow includes activities in the entity systems. The integration system might not know about what happens in these entity systems, only that the entity systems expect or produce certain data.

Choreography—the meshing between entity systems of business entities and their workflows.

Processing steps—actions that a runtime platform on which a workflow is implemented can take on data, including any configuration information needed to perform those steps.

Task—something a person does such as to run a test or configure something in a platform.

Recommendation—something the invention provides to a user so that the user can take the next step. A recommendation might derive from the results of a test. A recommendation might also derive from the current state of the configuration (e.g., the configuration of a workflow or a scoped portion thereof that has been tested) and the user's stated goals (e.g., to integrate with a particular ERP system or a given trading partner).

Variation—the term “variation” is used in this disclosure to describe different types of variations that may occur at different times and/or levels. For instance, the implementation level, there could be variations of paths in runtime flows. At the project management level, there could be variations in arrangement of tasks. At the task/tinkering level, there can be variations of tasks themselves. The integration system may make recommendations based on these different kinds of variations and, after each test of a workflow or a scoped portion thereof, a tester/tinkerer can choose to modify a configuration of the workflow accordingly and test the configuration again. This process can be repeated until the tester/tinkerer is satisfied and confirms that the testing is complete.

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

An information exchange platform operating in a network environment has the necessary resources (e.g., hardware, software, personnel, etc.) to provide managed services that enable the real-time flow or exchange of information electronically in the network environment in a secure, fast, and reliable manner, between and among disparate operating units, regardless of their standards preferences, spoken languages, or geographic locations. Examples of a network environment may include a distributed computer network or a cloud-based computing environment. Non-limiting examples of managed services may include translation services, format services, copy services, email services, document tracking services, messaging services, document transformation services (for consumption by different computers), regulatory compliance services (e.g., legal hold, patient records, tax records, employment records, etc.), encryption services, data manipulation services (e.g., validation), etc.

The information exchange platform operates to facilitate the real-time flow or exchange of information between disparate entities regardless of standards preferences, spoken languages, or geographic locations. The information exchange platform may be embodied on server machines that support the electronic communication method (e.g., EDI, API, etc.) used by various computers (i.e., client systems of the information exchange platform) that are independently owned and operated by different entities. In some embodiments, data formats supported by the information exchange platform may include EDI, XML, ebXML, RosettaNet, EDI-INT, flat file/proprietary format, etc. Supported network connectivity may include dial-up, frame relay, AS2, leased line, Internet, etc. Delivery methods supported by the information exchange platform may include store-and-forward mailbox, event-drive delivery, etc. Supported transport methods may include Hypertext Transfer Protocol (HTTP), File Transfer Protocol (FTP), and Simple Mail Transfer Protocol (SMTP), etc. Network security protocols supported by the Trading Grid may include Secure Socket Layer (SSL), Secure/Multipurpose Internet Mail Extensions (S/MIME), Internet Protocol Security (IPSEC), Virtual Private Network (VPN), Pretty Good Privacy (PGP) encryption protocol, etc.

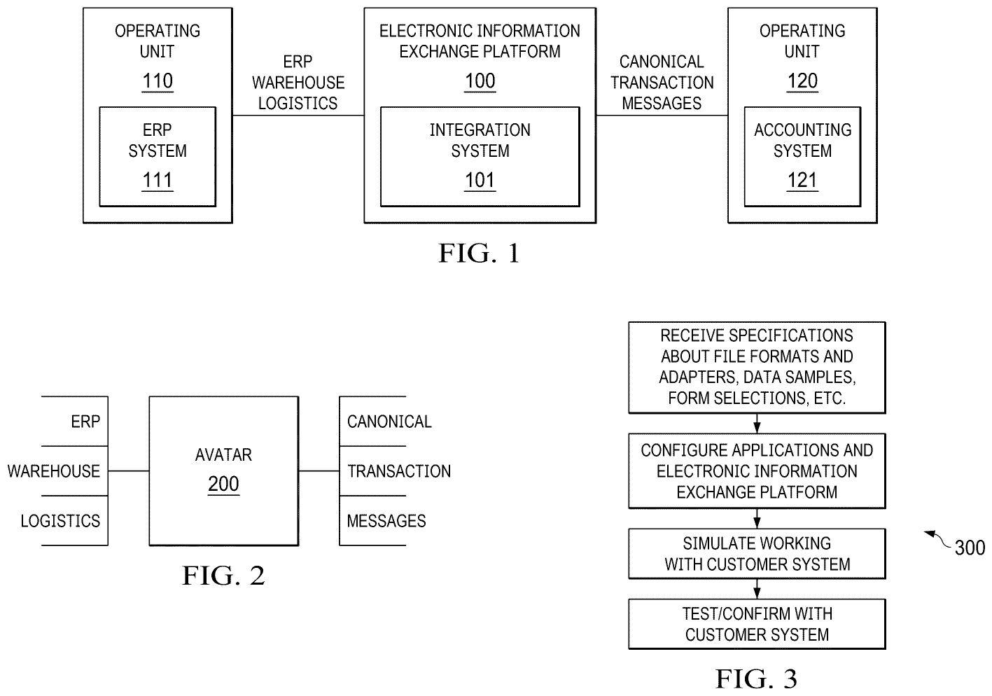

FIG. 1 depicts a diagrammatical representation of a networked computing environment where an electronic information exchange platform 100 operates to provide services to a plurality of operating units, including an operating unit 110 and an operating unit 120. In this example, operating units 110 and 120 are trading partners (TPs) of one another and the electronic information exchange platform 100 comprises an integration system 101 that presides over an integration between the operating units 110 and 120.

As alluded to above, the operating units 110 and 120 may conform to different standards and/or follow different data formats. As a non-limiting example, the integration between the operating units 110 and 120 may involve exchanging EDI X12 data, EDIFACT data, web forms, Comma Separated Values (CSV) files, and/or ERP data from an ERP system 111 of the operating unit 110 and canonical transaction messages from an accounting system 121 of the operating unit 120.

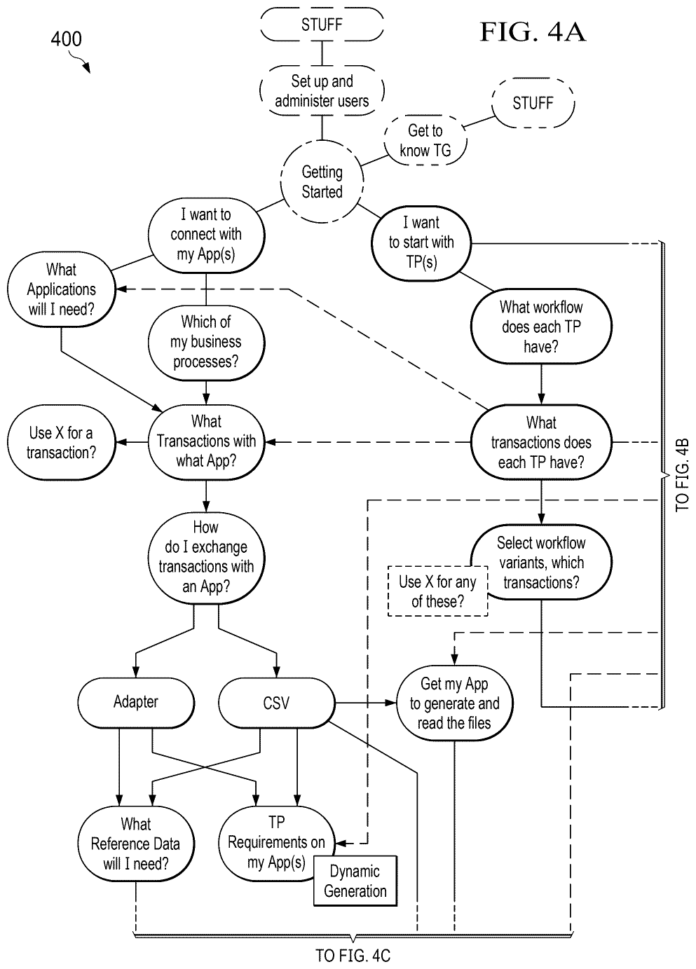

FIG. 2 depicts a diagrammatical representation of an avatar 200 that is part of an integration system (e.g., the integration system 101 shown in FIG. 1) operating on an electronic information exchange platform. As illustrated in FIG. 2, the avatar 200 is adapted to exchange EDI X12 data, EDIFACT data, web forms, CSV files, and/or ERP data with the canonical transaction messages. In other embodiments, an avatar for the operating unit 110 is adapted to exchange EDI X12 data, EDIFACT data, web forms, CSV files, and/or ERP data with an avatar for the integration system 101. The exchanged data is in an intermediary format internal to the integration system. An avatar for the operating unit 120 is adapted to exchange the canonical transaction messages with the avatar for the integration system 101. The exchanged data is in the intermediary format and the avatar for the integration system 101 is adapted to, according to a choreography, choreograph how the exchanged data moves between the avatars for the operating units 110 and 120. In this way, the integrated operating units 110 and 120 can communicate with one another over the electronic information exchange platform through these avatars so as to execute workflows.

Most workflows start by one party sending a transaction, which results in the exchange of other transactions. As a non-limiting example, a workflow instance could be instantiated when one party sends an “Order” transaction which results in the exchange of other transactions such as an “Invoice,” an Advanced Shipping Notice (ASN), etc.

In order to ensure workflows involving different entities can execute properly at runtime, at design time, an authorized user (of an integration system) may receive and/or obtain specifications about file formats and adapters involved in a workflow, as well as data samples and possibly forms (which can be those supported by the integration system). Then, based on the information received and/or obtained, the authorized user can configure applications involved in the workflow and configure the electronic information exchange platform for running the workflow. Once configured, the user can simulate how the configured workflow may execute at runtime and perhaps do an integration test run to confirm that the workflow executes as configured.

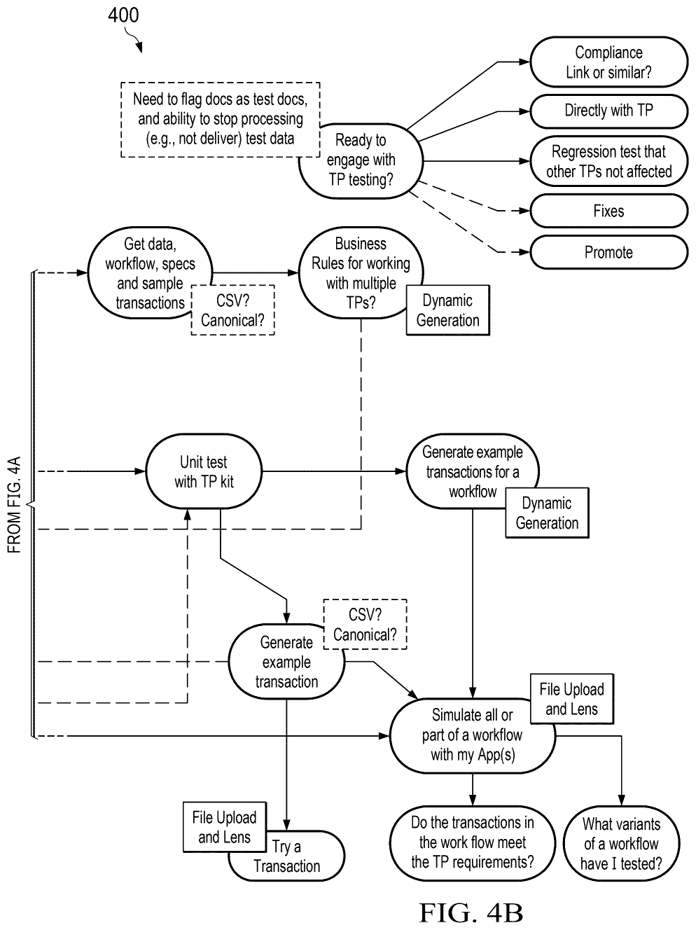

As illustrated in FIG. 3, such actions or tasks taken to set up an integration (which is realized in a workflow that moves data from one entity to another through automation implemented on the electronic information exchange platform) can be represented in a unidirectional linear process 300. However, truth is far more complicated in the real world. For example, a workflow might be part of a project (i.e., a project management workflow). In practice, setting up such a workflow is not a linear process as it may involve a team of users working on different sets of tasks having varying time and/or location constraints, and so on. These sets of tasks, which may differ from role to role, may be associated with reaching different milestones and may involve resources that might be shared. The sets of tasks may have dependencies of one another or otherwise be inter-related. For instance, one team may make changes to a task or tasks that would cause another team to also have to make a change or changes

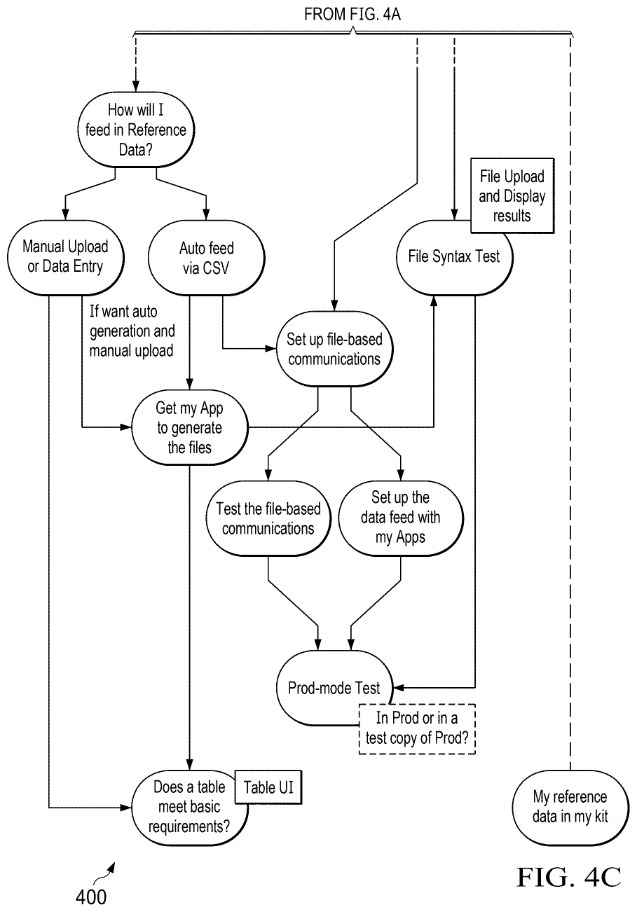

FIGS. 4A-4C together illustrate a more realistic multi-directional process 400 with decision points and sometimes disjointed tasks. As illustrated in FIGS. 4A-4C, setting up a system-to-system integration to run a workflow between entities can have paths extending from any one of the decision points and/or actions to any other decision point or action because, inevitably, customers will skip steps, change their minds, and/or need to go back to an earlier step, etc.

In this disclosure, the AI-assisted solution leverages avatars to streamline the process of configuring/testing an integration, for instance, at design time, maintenance time, upgrade time, etc. In some embodiments, each avatar is adapted to handle a particular type of data exchange between entity systems, an example of which is described above with reference to FIG. 2.

In general, avatars need reference data for maintenance and testing purposes. Avatars for sellers, or for customers playing other roles in a workflow, can need different reference data. Such reference data may be stored in small-to moderate-sized tables. As a non-limiting example, “ShipFrom” data can be used as reference data.

### Reference Data Discovery

Using a self-service tool provided by the electronic information exchange platform, a user can download the specification of the data format and communications methods specified by an operating unit (e.g., a customer of the electronic information exchange platform). As a non-limiting example, the operating unit has already specified the kind of avatar to be used to communicate with applications on their system (i.e., an entity system). The user reviews the documentation thus downloaded and considers an ERP or other application and its data generation and communication abilities. Then, the user utilizes the self-service tool to experiment with the application as needed and chooses a method for the electronic information exchange platform to communicate data with the application. Once the choice is made, the user can focus on the documentation and samples of reference data for the selected communication method.

### Reference Data Format and Data Completeness Verification Test

Following the example described above, the operating unit may have registered TPs. These TPs may have varying requirements for communicating with their applications/systems. For example, one TP may require a Global Location Number (GLN) for each “ShipFrom” location, and another TP may require a Data Universal Numbering System (DUNS) number for “ShipFrom” locations in the United States.

Suppose an entity system has generated data in an allowed data format, the user may navigate through a UI of the electronic information exchange platform and initiate a reference data upload test. In some embodiments, the integration system disclosed herein can be implemented on an orchestration server of the electronic information exchange platform. Through the UI, the user specifies a file name and a file type (kind) for a file. The user may optionally indicate whether to verify whether the file meets the integration needs of TPs (i.e., the requirements for communicating with their applications/systems).

Because the desired integration is not yet running, there is no chance of disrupting production data flows. Thus, a production environment that runs an instance of the electronic information exchange platform disclosed herein can be used to perform this verification.

The user uploads the file to the integration system which, in turn, validates the file. For instance, if a GLN field is populated with data, the value is checked to see if the value appears to be a valid GLN. At this time, if other checks are indicated, the integration system runs them as well—for instance, if a TP requires that the entity system sends the GLN in a message, the GLN is no longer optional, but is now mandatory for each “ShipFrom” location.

Through the UI, the integration system reports back any file formatting and data validity errors or that the file is structurally correct and passes all validation tests. The integration system may provide, through the UI, an option for the user to save the reference data in the electronic information exchange platform as an update to the reference data table (e.g., by removing all rows in the existing table and replacing them with the rows in this data sample).

### Reference Data Edit Session and Data Completeness Verification Test

Suppose an application on the entity system does not contain all the needed master data—for instance, some TPs require a GLN for every “ShipFrom” location, and some applications might not store such a value. In such cases, manual editing of reference data would be required.

As a non-limiting example, this can be done by first navigating the UI to a reference data editor. At this time, a reference data table exists and it might already hold data. The reference data editor pulls the reference data from the reference data table and presents, through a display device, the reference data to the user. The user enters and edits the reference data in the reference data table. Then, the user triggers or otherwise initiates a validation. In turn, the integration system validates the file. For instance, if a GLN field is populated with data, the value is checked to see if the value appears to be a valid GLN. If the user indicated a desire for running other checks, they are also run—for instance, if a TP requires the customer to send the GLN in a message, the GLN is no longer optional, but is now mandatory for each “ShipFrom” location.

The integration system reports back, through the UI, any data validity errors or that the data passes all validation tests. At this time, the user has the option to continue editing or save the updated reference data in the electronic information exchange platform as an update to the reference data table. The user can also decide whether to throw away the edited data.

In one embodiment, the UI provides a centralized place where the user can view the history of changes, which might have been made via an automated feed or by manual updates.

### Reference Data Regular Automated Feed

In some cases, an entity system can be adapted to upload or transfer a reference data file to the electronic information exchange platform. The reference data file is in a file format for reference data supported by the electronic information exchange platform. In such cases, the entity system can trigger the automated upload (e.g., by having a user placing the reference data file in a file folder or having an application on the entity system placing the reference data file in the folder). The integration system receives the reference data file, checks the syntax, performs all the necessary validity checks, records that the change took place, and records the new reference data from the reference data file in a corresponding reference data table.

If all validity checks passed, the reference data table is updated and the UI shows the completion status. In some embodiments, the integration system may perform a delta check to determine what rows of data have changed and report the changed rows of data through the UI. In some embodiments, the integration system may report any validity checks that failed and send out a proactive notification to an authorized user of the operating unit (e.g., by a text message, an email, etc.) so that the authorized user can perform self-support.

### Reference Data Expected Automated Feed

In some cases, an authorized user of an operating unit may provide the electronic information exchange platform with an expected schedule for the electronic information exchange platform to receive reference data. The integration system is adapted to, if a successful update of the reference data has not been received by the expected time as specified by the expected schedule, proactively send an alert through the UI. The alert indicates whether a refence data file was received or not, and if a reference data file was received, how to gain access to the errors that were found.

Customer Application Generating Data and the Electronic Information Exchange Platform Reading the Data

In order for meaningful communications to take place in an integration that involves multiple entity systems, the electronic information exchange platform must be able to read data generated by applications running on the entity systems (i.e., “customer applications”). As a non-limiting example, the electronic information exchange platform supports CSV files. Accordingly, customer applications should be configured or otherwise adapted to generate CSV files that can be read by the electronic information exchange platform and to read CSV files from the electronic information exchange platform. Techniques that can be used to configure customer applications are known to those skilled in the art and thus are not further described herein.

In some embodiments, the integration system may provide an enhanced UI that can be used to verify whether a customer application can correctly generate and/or read a sample data file (which contains items and prices of an order known to the customer application). The enhanced UI of the integration system may include an editor that allows an authorized user to import the sample data file and insert values into the sample data file. The authorized user then causes the integration system to send the sample data file to the customer application as an integration test. The enhanced UI, in turn, is updated to show the status of the test. The authorized user can open the sample data file in the customer application and view the results of the test. If an error occurred, the authorized user can adjust the application configuration and repeat the test.

### Workflow Testing

In this disclosure, a workflow between parties (e.g., an operating unit and its TP) enables them to transact with one another over the electronic information exchange platform. One party, such as the operating unit acting in a role as a seller, is an existing customer of the electronic information exchange platform. When the seller starts integrating with a buyer, which may or may not be an existing customer of the electronic information exchange platform, no one knows how to realize such an integration or what it takes to complete the integration so that the workflow can be successfully executed. The buyer has its internal processes, applications, data exchange standards, protocol communications, and various requirements (e.g., rules specifying whether EDI, RESTful APIs, or any other mechanism is used. It is entirely possible that the processes, applications, etc. of the buyer are rather different from those of the seller.

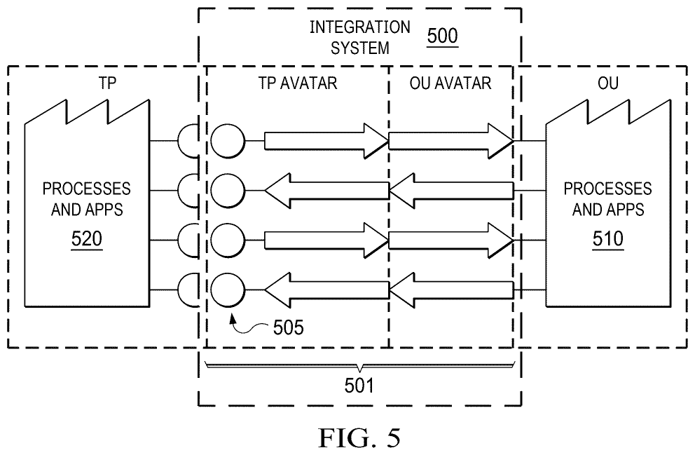

Instead of relying on an arduous manual process to try to figure out how to integrate the buyer's system with the seller's systems so that the workflow can be successfully executed by the electronic information exchange platform, as alluded to above, avatars implemented on the electronic information exchange platform (e.g., as part of the integration system) can be leveraged to allow the processes, applications, etc. of the buyer's system to work with those of the seller's system. FIG. 5 is a diagram that illustrates an example of an operating unit (OU) and its TP communicating with one another through their respective avatars.

In the example of FIG. 5, the OU has a set of processes, applications, requirements, etc. 510 and the TP has a set of processes, applications, requirements, etc. 520. The OU, acting in a seller role, wants to work with the TP in a buyer role in a workflow. While seller and buyer roles are used in this example, those skilled in the art will appreciate that different workflows may involve different roles and, therefore, this disclosure is not limited to the seller and buyer roles. In this example, the OU is associated with an avatar particularly set up for the OU (i.e., the “OU avatar”) in an integration system 500 and the OU's system is able to communicate successfully with the OU avatar, as described above (e.g., data generated by an application on the OU's system can be successfully read by the integration system 500 and data from the integration system 500 can be successfully read by the application on the OU's system, referred to herein as an entity system, as described above). As a non-limiting example, either side of the integration system 500 can be a data warehouse. Also known as an enterprise data warehouse system, the data warehouse is used for reporting and data analysis and is considered a core component of business intelligence.

Utilizing a self-service/self-testing tool (which can be made available through an enhanced UI of the integration system 500), an authorized user can tinker and test how and whether the OU avatar is able to communicate with an avatar for the TP (i.e., the “TP avatar”) so as to allow an instance of the workflow (e.g., a workflow instance 501) to complete. As a non-limiting example, the authorized user may be an EDI subject matter expert (SME). At this time, even an EDI SME can face the following challenges:
An inbound transaction might not contain all the data an application needs.
An inbound transaction may contain necessary data that the application cannot (yet) consume
Getting realistic test data for every variant of an inbound transaction
Getting realistic data that could reasonably be part of a specific workflow instance (e.g., if the workflow instance involves an order that includes three line items, ensuring that a later inbound test transaction in the workflow instance refers to the same three line items so that the application being tested can exercise its appropriate logic)
Ensuring an outbound transaction meets the general requirements of a transaction
Ensuring an outbound transaction could reasonably be part of a specific workflow instance (e.g., if an order included three line items, ensuring that the outgoing transaction in the workflow instance refers to the same three line items).
An outbound transaction requires data that the application does not have or cannot be reasonably produced by the application.

### Getting Realistic Inbound Test Data

In some embodiments, the integration system 500 can validate the needed requirement of the transaction. For example, if the integration system 500 has knowledge of the items that the OU sells, the integration system 500 can verify that the items listed in the order do exist. At a minimum, the integration system 500 is adapted to verify that the transaction looks like a given requirement of the transaction and not like some other requirements of the transaction. Below are examples of how a tester (i.e., a tester) may use the self-service/self-testing tool. Note that, in the examples of FIG. 5, the generated data might be in a format sent by a TP, in a format exchanged by the avatars, or in a format conforming to any of the processes, applications, and/or requirements 510 of the OU.

### Example 1

The tester logs into the enhanced UI of the integration system 500. The tester specifies the TP, a transaction, a workflow section, and a workflow variant. If the transaction is at a later stage in the workflow, the tester might also need to provide earlier transactions in that workflow instance. The enhanced UI presents the tester with a generic transaction that includes some basic information (e.g., if the workflow involves generating an invoice, an “Order Number” would have been inserted into the invoice). The enhanced UI then displays a form (which can be internal to the integration system) that allows the tester to edit some of the information (e.g., the items, price, quantity, etc., for an order). Once the tester submits the form, the integration system performs a validation, and if any error or problem is found, notifies the tester so that the tester can correct the error or address the problem. Through the enhanced UI, the tester can download a test data file that contains data about the test.

### Example 2

The tester logs into the enhanced UI of the integration system 500 and starts an editing session (e.g., using an editor provided by the integration system 500). The tester specifies the TP and a workflow instance. The integration system 500 provides an initial transaction T (e.g., an inbound order). The tester edits the transaction T (e.g., the items, price, quantity, etc., for the inbound order) as needed or desired and initiates an integration test run of the transaction T. The integration system 500 starts the workflow instance 501 based on the transaction T and, through the self-service/self-testing tool, provides information about each processing step of the integration test run.

As illustrated in FIG. 5, the workflow instance 501 involves both the OU avatar and the TP avatar. If the OU avatar and/or the TP avatar have decision points that trigger specific processing or validations, relevant information is made visible to the tester through the self-service/self-testing tool. Each processing step of the workflow validates the data against the TP's requirements for the variant, and any other applicable validations.

In some embodiments, each time the workflow has the TP needing to produce the next transaction in the workflow, the self-service/self-testing tool produces a sample transaction. The tester has the option to edit and validate the sample transaction. Then, the workflow continues. Once the workflow ends, the tester has the option to take a snapshot of the test run which can later be replayed as a regression test, assuming that the OU applications involved have the same behavior during the replay as happened in this test.

### Testing a Single Inbound Portion of a Workflow

The electronic information exchange platform is adapted to orchestrate processing of various types of documents. A workflow describes a processing model for processing a particular document type. Each workflow is associated with a data flow tuple. Each data flow tuple is created for processing a file from an entity system (e g., the OU's system).

In some embodiments, integration tests can be started at the start of a workflow, but not in the middle of a workflow. If a transaction is not at the start of a workflow, preparing an application (that runs on the OU's system) to receive a test transaction might be difficult—for instance, previous transactions may need to be replayed so that the application is ready to do the integration test. If the integration test is a repeated test, the data from the previous run may need to be cleared out of the application, or the test file may need to be updated with a different document number or other identifiers so that the application treats it as a new transaction. The example below assumes that a tester has a test transaction and can configure the application to be ready to receive the test transaction.

The tester logs into the enhanced UI of the integration system 500 and is ready to run an integration test on a test transaction. As a non-limiting example, the test transaction can be a JavaScript Object Notation (JSON) message canonical. The tester uploads the message canonical for the transaction and starts the integration test. The integration system 500 hands the test transaction to the workflow of the OU avatar. Data flows through the processing steps of the workflow until the integration test completes. Through listeners embedded in each component of the electronic information exchange platform, the integration system 500 can listen to communications among components of the electronic information exchange platform as data flowing through the processing steps.

The self-service/self-testing tool presents the results of the integration test through the enhanced UI. The tester views the results (which can also be visible through an UI of the application). If the OU avatar and/or the TP avatar have decision points that trigger specific processing or validations, relevant information is made visible to the tester through the UIs as well.

### Testing a Single Outbound Portion of a Workflow

In some cases, a tester may wish to trigger an outbound transaction from an application as data is in the application. In these cases, the integration system is adapted to stop processing at a desired time. As a non-limiting example, the tester has configured the integration system and the integration system is ready for a test. The tester causes the application to generate a transaction. The integration system receives the transaction and triggers a workflow of the OU avatar. Data flows through the workflow until the integration test completes (e.g., triggering an workflow of the TP avatar so as to test TP-specific behaviors and ensure that the data meets the requirements of the TP). Data is not delivered to the TP as the workflow of the TP is triggered, but is not followed through. As in other cases, the tester can view the results of the integration test through the enhanced UI and/or the application. If the OU avatar and/or the TP avatar have decision points that trigger specific processing or validations, relevant information is made visible to the tester through the UIs as well.

Validation by Exchanging Data with a TP

Many validation methods may be used to verify the validity of an integration test of a workflow or a portion thereof. For instance, assuming that an OU avatar is configured (e.g., with a reference data file) and an instance of the electronic information exchange platform is set up to exchange EDI data with a TP of the OU, in the test mode, the integration system may receive a message (e.g., an EDI test order) from the TP to the OU. In response, the integration system starts an workflow for processing the EDI test order from the TP, pulls the reference data (e.g., a CVS file), starts any necessary adapter (e.g., adapters 505 shown in FIG. 5) and/or avatar (e.g., a supervisory avatar that oversees how OU and TP avatars working with one another), and presents the processing information through the enhanced UI.

More specifically, the arrival of the message from the TP triggers an integration activity which utilizes a set of handlers. The integration activity follows a choreography, which has a choreography key. The choreography key defines and governs how data is moved through the choreography. The set of handlers, which is provided by the integration system, is capable of interacting with multiple APIs, files, and databases to extract or inject necessary data for a plurality of integration activities. The behaviors of the set of handlers are guided by configuration files stored on the integration system. Examples of the choreography, choreography key, and handlers are described in the above-referenced U.S. Patent Application Publication No. 2023/0359968.

The integration activity may result in the integration system sending EDI data to the TP through the TP avatar. The TP receives the EDI data and initiates the next processing step in the choreography. The tester can repeat this validation process for all variants of all workflows that need to be tested.

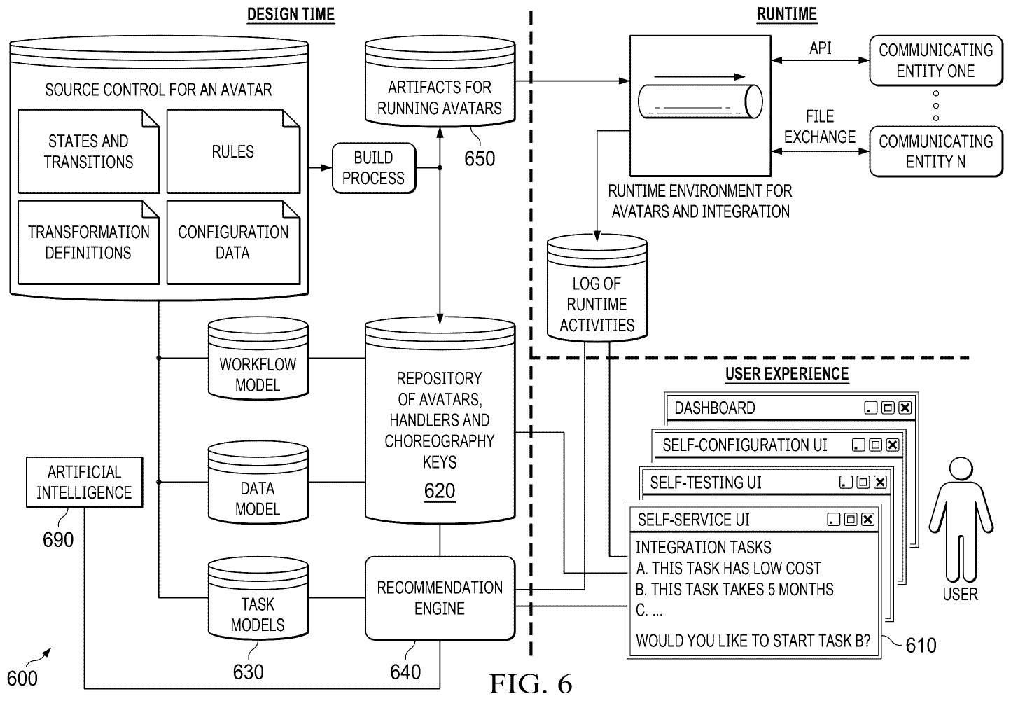

FIG. 6 is a diagrammatic representation of design time components and runtime components of an example of an integration system 600 having an enhanced UI 610 (which can comprise a self-service UI, a self-testing UI, a self-configuration UI, and a dashboard which can provide a progress report, a summary report, etc.), a workbench or dashboard for a self-service/self-testing tool), a repository 620 storing avatars, handlers, and choreography keys, task models 630, a recommendation engine 640, and integration artifacts 650 (e.g., scripts, data maps, etc.) for running the avatars. The recommendation engine 640 can leverage the power of artificial intelligence 690 to make recommendations that might related to automation on the electronic information exchange platform. For example, AI-based mapping tool can be used to create a new data transformation map when it is shown that generic maps from EDI data to the canonical are inadequate. That is, once an error is found in a test, an AI-based tool can be used to communicate automated, AI-driven changes to the recommendation engine 640.

In some embodiments, the enhanced UI 610 can be implemented in many ways. For instance, the self-service UI is adapted to help a user with higher-level work, such as deciding which tasks to do; the self-testing UI is adapted to help the user to perform test-related functions; the self-configuration UI is adapted to help the user to perform a specific configuration task, configure a test, etc. There can be configurations of tests as well as configurations of workflows and processing steps. At runtime, the communicating entities can include an OU's own applications, data warehouses, etc.

As illustrated in FIG. 6, the avatars, handlers, and choreography keys are created and stored at design time. The integration artifacts 650 are built, through a build process, at configuration time of each avatar.

After logging into the enhanced UI 610, the integration system 600 may present a set of questions (which can be generated by the recommendation engine 640) that can guide a user (e.g., a tester) to decide what to do next in order to realize a goal (e.g., setting up an integration, testing a workflow or a portion thereof, etc.). For self-service/self-testing, the integration system 600 may provide documentations and examples, such as those described above, that explain how the user may set up and test an integration.

In some cases, configuring an integration may involve tasks with inter-dependencies. The integration system is adapted to hold dependencies for a task that must be met before that task can be completed. For instance, according to a workflow model or definition, a first task of a workflow depends on completion of a second task of the workflow. At runtime, instead of waiting for the second task to complete, the integration system is adapted to allow execution of the workflow to ignore this dependency and proceed without flagging the incompleteness of the second task as an error. The integration system may nevertheless notify the tester that the dependency is being held. The recommendation engine 640 may analyze tasks involved in the workflow and, using a task model and through the enhanced UI 610, recommend tasks (and perhaps in what order) that the tester can take in order to meet the goal. Through the enhanced UI 610, the tester can drill down and explore each task for more information.

Because the integration system can hold the dependencies, certain integration activities (e.g., taking tasks out of order, exiting and restarting a workflow, etc.) can be performed without triggering error messages and/or without having to terminate a test. The documentation and examples help to communicate why certain choices are advantageous, and why doing certain tasks prior to others can be beneficial in achieving the goal. The documentation and examples can be updated continuously or periodically, providing better guidance for users over time.

If testing a workflow or a scoped portion thereof causes an error, the integration system can provide information about the error through the enhanced UI. The integration system allows the tester to return to an earlier processing step and make any changes that might fix the error. Additionally or alternatively, the tester may need to take a different path or make alterations and/or redo several processing steps. In a sense, the self-service/self-testing tool provides the guidance and resources to help the tester in taking a journey to reach the goal and, along the various paths to the goal, provides insights as to where the tester is.

For instance, to reach a given state or milestone (e.g., producing a data bundle needed in the integration), there might be hundreds of configuration tasks to achieve some results (which correspond to hundreds of processing steps to reach a runtime milestone). The integration system is adapted to track the tasks, updates a status indicator accordingly, and displays the status indicator in the enhanced UI. If elapsed time, effort, etc. are known, the integration system can combine the information with external data (e.g., data from an entity system) to indicate a ratio of efforts made relative to what is remaining, the time estimate as to when the goal might be reached, etc.

In some embodiments, user decisions made using the self-service/self-testing tool are recorded (e.g., through listeners embedded in the electronic information exchange platform). For instance, if a user chooses to use a certain set of APIs to exchange data with an application, that information is recorded. If customizations are done so that an API can now exchange additional transactions with the application, that information is also recorded. The recorded information can be used as feedback to the recommendation engine 640.

In some embodiments, the recommendation engine 640 takes a task model as input. The task model is an internal model of configuration and implementation tasks that can be taken, with variants, dependencies, information needed for each task, and documentation. The user can explore information and configure the integration capability (e.g., how a buyer's system communicates with a seller's system over the electronic information exchange platform). As alluded to above, the recommendation engine 640 can recommend next tasks (based on the task model thus inputted) needed to reach the goal, even if the dependencies of the recommended tasks are not yet in place, and explain the best practices around the next tasks (e.g., “Task B takes less time than Task A. Would you like to start Task B?”).

In some cases, a team of testers may collaborate in configuring an integration. For instance, one tester may focus on a first set of tasks and another tester may work on a second set of tasks. In some embodiments, the integration system records, in a single configuration file, all the tests done in the test mode by all the testers in the team. In some embodiments, tasks could be tested separately in different-mostly non-overlapping-scopes. In such cases, the integration system may merge the configuration files (i.e., non-overlapping configurations for the tasks thus tested) into a single configuration file. Additionally, audit information (e.g., who did what) can be recorded or logged into a work-tracking system (e.g., a community project, etc.).

In some embodiments, the enhanced UI can be implemented to provide various UI pages, including, but are not limited to, an enhanced UI which provides a trigger to start an integration test (in a particular scope), a tinkerer's workbench (i.e., self-service) for showing a task view of tasks that are done, in progress, broken, etc., a configuration UI which allows a user to make changes implement or modify platform/integration capabilities in a development environment, and a reporting dashboard that allows a user to chart progress and current hypotheses toward goals, as well as work that has been completed and certified as working. As a non-limiting example, the reporting dashboard is adapted to provide a progress report that includes a summary view.

When a user needs to make a change to something that is already working, the modification is recorded as a new goal. Using the self-service/self-testing tool, the user can progress toward adjusting prior work to conform to the new goal in the same way as described above.

### Example Self-Service/Self-Testing

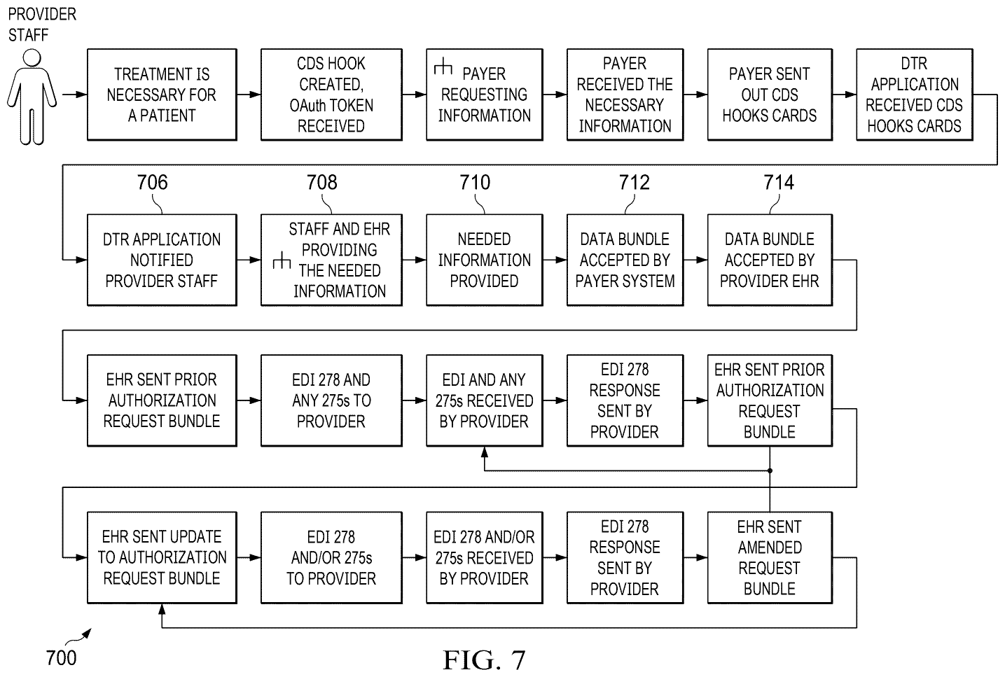

FIG. 7 provides a summary view of an example of a workflow 700 to be implemented on an electronic information exchange platform. In this example, the workflow 700 involves a plurality of processing steps, including steps 706, 708, 710. These processing steps can be configured via corresponding tasks. These processing steps involves an Electronic Health Record (EHR) system and a Documentation Templates and Coverage Rules (DTR) application. The DTR application, which is an application generally used in a doctor's office, is a complex, standalone application. Typically, a user will log into the DTR application and performs a series of actions such as filling out information in a document, printing the document, and taking the document to a mail courier or faxing the document to an EHR system and/or to a Payer system. The user may need to document what needs to happen for the Payer system so that the Payer system can use the document generated by the DTR application. This is a very inefficient, time-consuming, and costly process.

In the example of FIG. 7, the DTR application needs information from the EHR system (and perhaps user input) in order to generate a data bundle needed by downstream processing steps (e.g., tasks 712, 714) in the workflow 700. However, the DTR application is a standalone application that is not set up to communicate with the EHR system through the electronic information exchange platform. Therefore, the DTR application and the EHR system do not communicate over the electronic information exchange platform. Instead, a user acts on behalf of both applications and manually review and provide the output from the EHR system (e.g., a printed report, a fax document, etc.) as input to the DTR application (e.g., through input fields displayed in a UI of the DTR application). Once the DTR application has the needed information 710, a data bundle is generated. The user then adds documentation about the data bundle and sends the data bundle to the EHR system and a target system (e.g., the Payer system).

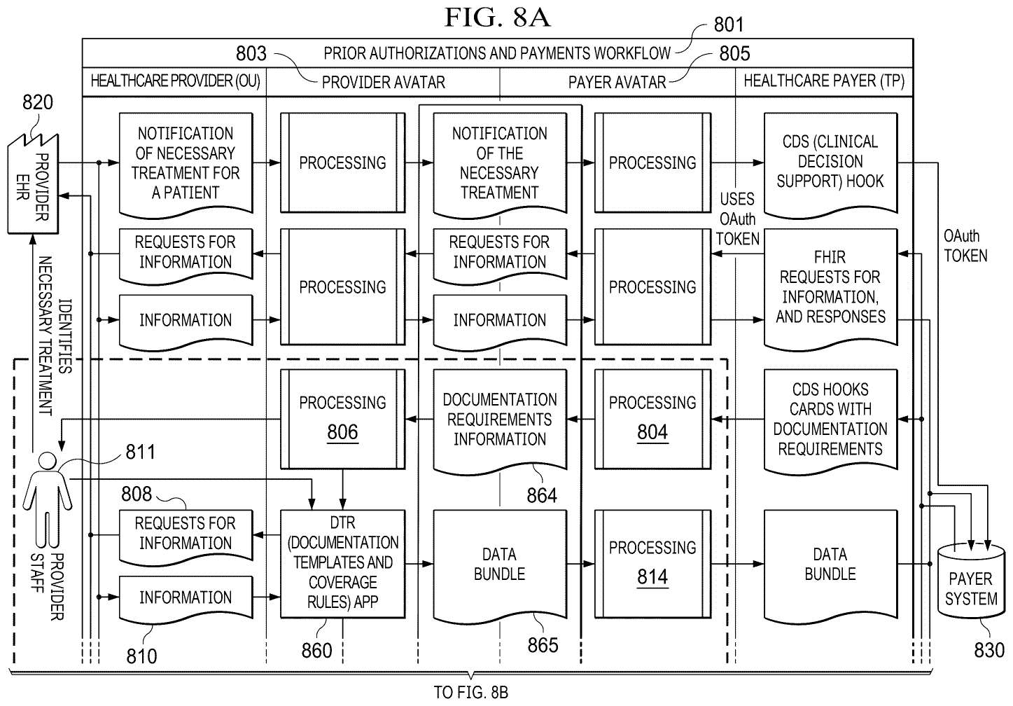

FIGS. 8A-8B diagrammatically illustrate how a self-service/self-testing tool and avatars running on an electronic information exchange platform can be utilized to test and configure an integration between the EHR system and the DTR application in order to reach a milestone (e.g., producing a data bundle). As a non-limiting example, a Prior Authorizations and Payments Workflow 801 is to be implemented on an instance of an electronic information exchange platform. The electronic information exchange platform includes a testing framework that supports a variety of tests internal to the electronic information exchange platform. In this case, the testing framework is adapted to support the self-service/self-testing tool.

The electronic information exchange platform can be implemented as a muti-tenant system that runs in a cloud computing environment in a test mode or a production mode. To conduct an integration test, a tester 811 logs into an instance of an electronic information exchange platform in the test mode. In this case, the tester 811 is associated with a tenant of the muti-tenant system.

In some embodiments, the testing framework includes an internal model of tasks. There can be multiple task models, each of which specifies a progression of steps from the beginning to the end for a certain type of integration. These can be considered as starter task models. Each starter task model can be created based on feedback from subject matter experts. For instance, a professional working in the financial industry is familiar with a loan application process. A starter task model that models a loan application process can specify what tasks, and variations of tasks, are needed for this loan application process, from the beginning to the end. That is, a starter task model can include a sequence (i.e., what order) of what tasks to perform for a specified goal and a configuration that describes any predecessor and/or dependency of each task as well as possible implementation of these tasks (e.g., what user interaction with a UI is to be expected, what workflow processing steps, such as making an API call to an entity system, are to be expected, etc. The specifics of such starter task models can vary from implementation to implementation.

As illustrated in FIG. 8A, according to a particular task model, the Prior Authorizations and Payments Workflow 801 includes certain processing steps. In this example, these processing steps are performed by respective avatars of an OU and its TP (e.g., a Healthcare Provider and a Healthcare Payer) and involves actions taken by an entity system 820 and/or the tester 811.

In the example of FIGS. 8A-8B, when the tester 811 logs in and indicates, through an enhanced UI, a desire to start an integration test, the enhanced UI may present the Prior Authorizations and Payments Workflow 801 and allow the user to identify (e.g., by clicking or touching) a scope 880 for the integration test. For tracking purposes, a scope identifier (ID) is assigned (e.g., by an integration system which runs the self-service/self-testing tool and operates the Prior Authorizations and Payments Workflow 801 and the avatars 803, 805 in the test mode).

In the Prior Authorizations and Payments Workflow 801 (which is not yet implemented on the electronic information exchange platform at this time), a processing block 806 is shown feeding data to the DTR application 860. The processing block 806 is a predecessor to the DTR application 860. However, since the DTR application is a standalone application not yet on the electronic information exchange platform, the tester 811 may want to skip the DTR application and build out the latter part of the Prior Authorizations and Payments Workflow 801 first. This is possible because the underlying integration system can hold the DTR application's dependency to the predecessor to allow testing of the DTR application at a later step and manually feed the data for testing purposes.

Thus, when the integration system receives a request to start the integration test, even if a predecessor to the DTR application has not been configured or otherwise implemented (i.e., the predecessor is not yet connected to the underlying electronic information exchange platform), the integration test is allowed to start with the DTR application (i.e., the DTR application's dependency to the predecessor is noted but ignored). The integration system does not deny the integration test request or fail the integration test for dependency errors. Rather, it gives out a warning that a predecessor has not been done and allows testing of processing steps downstream from the DTR application. This is a possible scenario because the tester, as well as the integration system, may not have knowledge on where to “properly” start setting up (i.e., configuring) and testing the integration. Naturally, the testing of processing steps downstream from the DTR application fails because the necessary output (e.g., a data bundle 865) from the DTR application is missing. The integration system provides the result (i.e., the configuration of the integration test which did not make progress in making the Prior Authorizations and Payments Workflow 801 work) and suggests going back up a processing step (e.g., upstream from the DTR application 860). At this time, the tester 811 can be directed to an enhanced UI (e.g., a tinkerer's workbench). An authorized user (who can be the same tester 811 or someone else) can tinker with different ways to get the necessary output from the DTR application.

The task model corresponding to the Prior Authorizations and Payments Workflow 801 shows that the DTR application needs a piece of information (e.g., the documentation requirements information 864). Ideally, the processing block 806 upstream from the DTR application 860 supplies the piece of information. However, since the DTR application 860 is not yet integrated, when the processing block 806 informs that its processing is complete and ready for the next processing block, a user (e.g., the tinkerer) logs into the DTR application 860 and performs the typical steps that they normally would do so they can simulate what the processing block would do-feeding data into the DTR application 860, as if the next processing block has received a notification from the upstream processing block 806.

In some embodiments, a team of users may collaborate to configure and test the Prior Authorizations and Payments Workflow 801. Each user may focus on a set of tasks specified in the task model, even working in parallel. For instance, an earlier task might involve registering a test DTR application with the electronic information exchange platform so that it has the ability (e.g., hooks) to interact with other systems on the electronic information exchange platform through API calls. Each user runs their own tests on how to make some kind of conversation possible over the electronic information exchange platform. As each user configures a sequence of tasks (e.g., which corresponds to a user-specified scope such as the scope 880), the integration system records steps done (and mark them as “test steps”) and aggregates results (i.e., configurations) from tests conducted by the users. The configurations, which can be in the form of non-overlapping (or mostly non-overlapping) configuration files, are stored in a centralized place.

Accordingly, initially, a tinkerer may obtain some kind of output from the processing block 806 and use the output as input to the DTR application 860 so that the processing block 814 downstream from the DTR application 860 can proceed as usual as if the processing block 814 was able to interact with the DTR application 860 (i.e., as if the DTR application 860 is already integrated). That is, for testing purposes, the tinkerer may first interact (e.g., sending a request for information 808 and receiving the requested information 810) with the EHR system 820 on behalf of the DTR application 860. Once the DTR application 860 has the needed piece of information, it creates a data bundle 865. The tinkerer may then send the data bundle 865 to the EHR system 820 and the processing block 814.

The tinkerer's interactions with the EHR system 820 and the processing block 814 are captured (by listeners embedded in components of the electronic information exchange platform) and recorded by the integration system (e.g., using the scope identifier). The test results are shown through the dashboard and the tinkerer can use the enhanced UI to tinker (change) the configuration under testing and rerun the test. This time, with the updated configuration, the processing block 806 is able to provide the documentation requirements information 864 to the DTR application 860 and inform the DTR application 860 to start its processing.

Based on the documentation requirements information 864, the DTR application 860 (which is now performed by the Provider avatar 803 operated by the integration system), in turn, automatically sends a query for information 808 to the EHR system 820 and receives a response with the requested information 810 from the EHR system 820. At the end of this retest, the conversation between the EHR system 820 and the DTR application 860 is automated. The tinkerer can provide documents, reports, etc. that are part of the data bundle 865, if necessary, and then the data bundle 865 can get sent over to the EHR system 820 and a test Payer system through the processing block 814 performed by the Payer avatar 805.

The above example illustrates a possible path through a workflow between the processing block 806 and the DTR application 860. Through the enhanced UI, the self-service/self-testing tool may present various possible paths to reaching the desired milestone as recommendations to the tinkerer (who can be the tester 811 or someone else). The tinkerer may test a path (e.g., by manually invoking the DTR application 860 and causing the DTR application 860 to generate requests 808 for information, receiving the requested information 810 from the entity system 820, and generating the data bundle 865 utilizing the received information 810) and, through the enhanced UI, inform the self-service/self-testing tool of the steps (i.e., “test steps”) taken by the DTR application 860 along the path to interact with the Provider system 820. The test steps are recorded in a configuration file accessible by the Provider avatar 803 when performing a system-wide test (i.e., testing the Prior Authorizations and Payments Workflow 801 from the beginning to the end). Progress of these tests (i.e., testing of the Prior Authorizations and Payments Workflow 801 or a portion thereof) can be reported through the dashboard, which shows summaries of behaviors of data moving back and forth between test entity systems and the electronic information exchange platform. While in the test mode, none of the data is delivered to the actual Payer system. Rather, the trace of activities is reported to the testing framework and used by the integration system to make recommendations (with supporting documentation and/or examples) as what to do next in configurating and testing the Prior Authorizations and Payments Workflow 801. The integration system is adapted to monitor whether each test is successful (e.g., the processing steps in the scope 880 were performed without causing an error message and with a data bundle successfully generated) and requests confirmation on the success of the test. In the end, a system test may be performed to send sample data to the test Payer system in the test mode. Once the system test is confirmed a success, the Provider EHR 820 may notify the Payer system 830 and the electronic information exchange platform is ready for a conversation between these entity systems in the production mode as the DTR application 860 has been successfully integrated for implementing the Prior Authorizations and Payments Workflow 801 on the electronic information exchange platform.

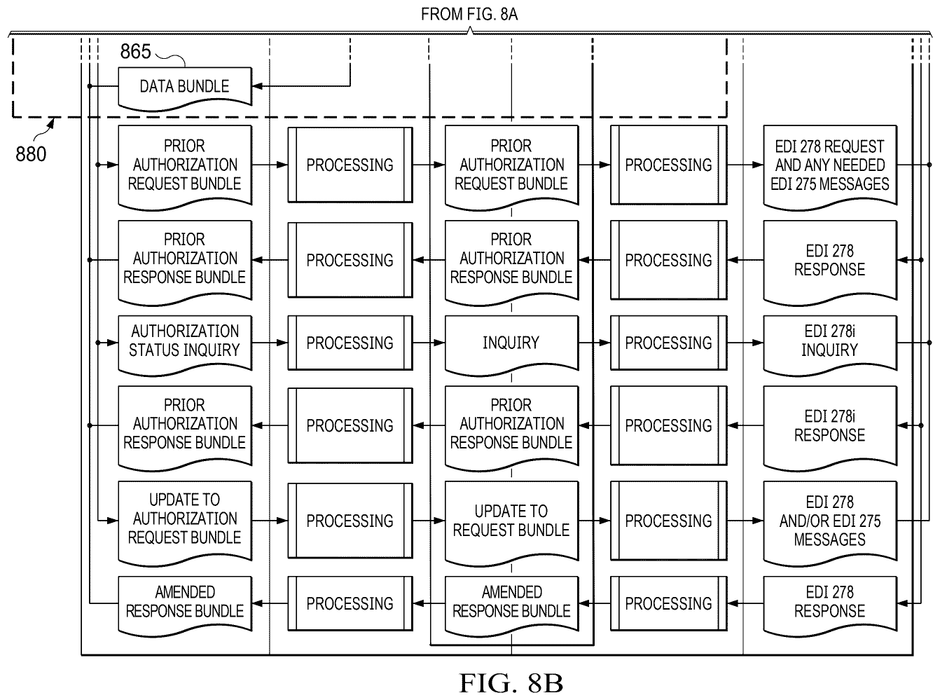

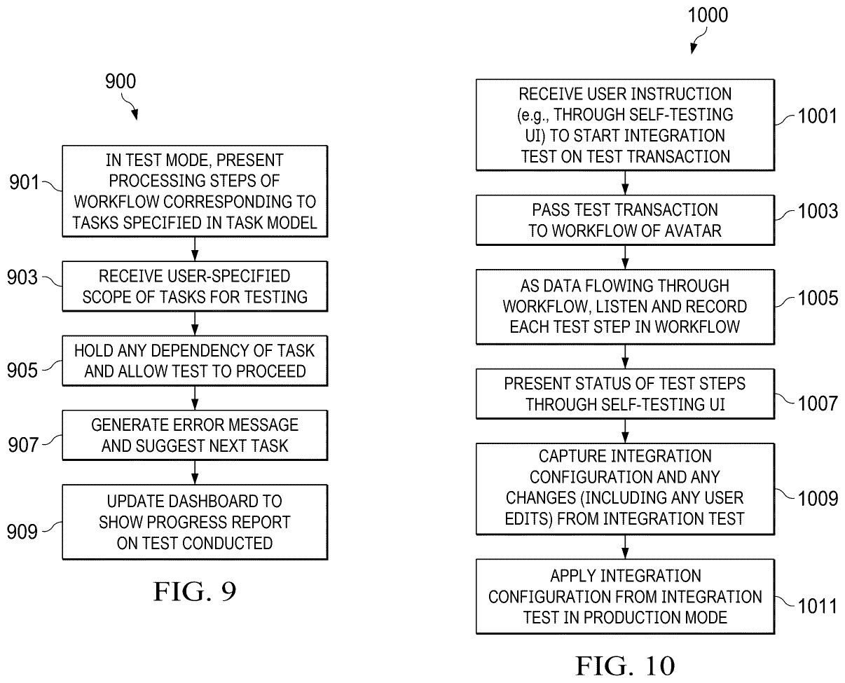

FIGS. 9-10 are flowcharts that illustrate actions performed by the self-service/self-testing tool disclosed herein, according to some embodiments. As described above, the self-service/self-testing tool can be part of a testing framework of an electronic information exchange platform. The test framework includes task models. Each task model, which includes a configuration file and a reference data file, simulates a sequence of tasks needed to reach a milestone or to complete a workflow from start to finish, using the configuration file and the reference data file. Variations of these tasks may also be generated. These variations can be taken to reach the same milestone or to complete the same workflow from start to finish.

According to FIG. 9, in the test mode, an integration system implementing the self-service/self-testing tool is operable to present to a tester (e.g., through an enhanced UI) the processing steps of a workflow to be implemented on an electronic information exchange platform (901). Depending on the type of workflow, the processing steps shown may correspond to tasks specified in a task model.

The enhanced UI is adapted to allow the tester to identify a scope of the processing steps for testing (903). One or more of the processing steps in the scope may have a dependency on a predecessor. The integration system is adapted to hold or flag this dependency and allow the test to proceed or continue (905). The integration system may consider variations of the tasks in the scope and, when the test fails, suggest alternative paths based on the variations of the tasks in the scope. The integration system may generate an error message and present the paths as recommendations through an enhanced UI (907). In some embodiments, each recommendation is associated with an explanation and/or documentation that describes benefits and/or advantages for the respective recommendation. The above-described process can be repeated for different tests. The result (i.e., the configuration used to run a test) can be presented through a dashboard (909). As described below, each test can be used to update an overall configuration for the workflow.

FIG. 10 illustrates a method 1000 for self-testing an integration. In some embodiments, an integration system implementing the method 1000 may receive (e.g., through an enhanced UI of the self-service/self-testing tool), a user instruction to start an integration test on a test transaction as described above (1001). The integration system passes the test transaction to a workflow of an avatar (e.g., an OU avatar for an inbound test or a TP avatar for an outbound test) (1003). As data flowing through the workflow, the integration system listens and records each processing step in the workflow (1005). The integration system also updates the status of the workflow accordingly, for instance, through the enhanced UI of the self-service/self-testing tool (1007). The integration system captures the integration configuration (e.g., one that is used by the workflow) and any changes to the integration configuration in a configuration file for the integration being tested (1009). The configuration file can be used in running the integration in the production model (1011).

Additional embodiments of the invention are directed to methods, systems, and techniques for testing a plurality of tasks executing between and among entities on a transactional system. A test system in conjunction with a tester, work together to properly configure the set of tasks that accomplish goals which characterize, but are not limited to, a workflow, project, interaction, interface, process, action etc. (hereinafter generally referred to as “workflow” composed of “processing steps”). Within such a set of tasks exist one or more undefined tasks, which are undefined and/or not configured with current configuration information defined on the transactional system (i.e., not yet integrated with the transactional system).

The test system identifies an undefined task (corresponding to processing steps that are not fully configured) and generates configuration information for the processing steps, which helps the user to complete the corresponding task. Configuration information comprises, but is not limited to, data variables and parameters, implementation options such as function handlers, APIs, user input, required and/or desired functionality, external parameters, pre-existing information that may feed into the configuration information such as kits, content templates, content rules, and more. A test is then initiated to test the undefined task on the transactional system simulator with the generated and proposed configuration information. If the test returns successfully, the test system may move on to the next undefined task, and so on. Otherwise, the test system may regenerate configuration information and once again test the processing steps with the new configuration information.

This process may continue until the task (and corresponding processing steps) is properly configured, resulting in an overall successful workflow occurring between and among the entities to achieve the goal. In some embodiments, the test system is flexible enough to configure an undefined processing step and modify a previously configured processing step because of changes the later configured processing step may bring to the overall workflow.

It is often the case that an entity needs and/or desires to interact with one or more other entities to accomplish a goal, but such interaction is not fully defined or expressed. One of the advantages of the invention is the ability to allow and facilitate successful completion of a workflow between entities which may only partially be defined. Here, the entity may execute the test system to identify, test and to “tinker” with a simulation of the interaction on the transactional system. In a way, the test system and method are self-service workflow compilation architectures, approaches, and techniques that prospective entities may use to design, configure, and test a workflow to complete the workflow definition and properly execute and deploy the workflow.

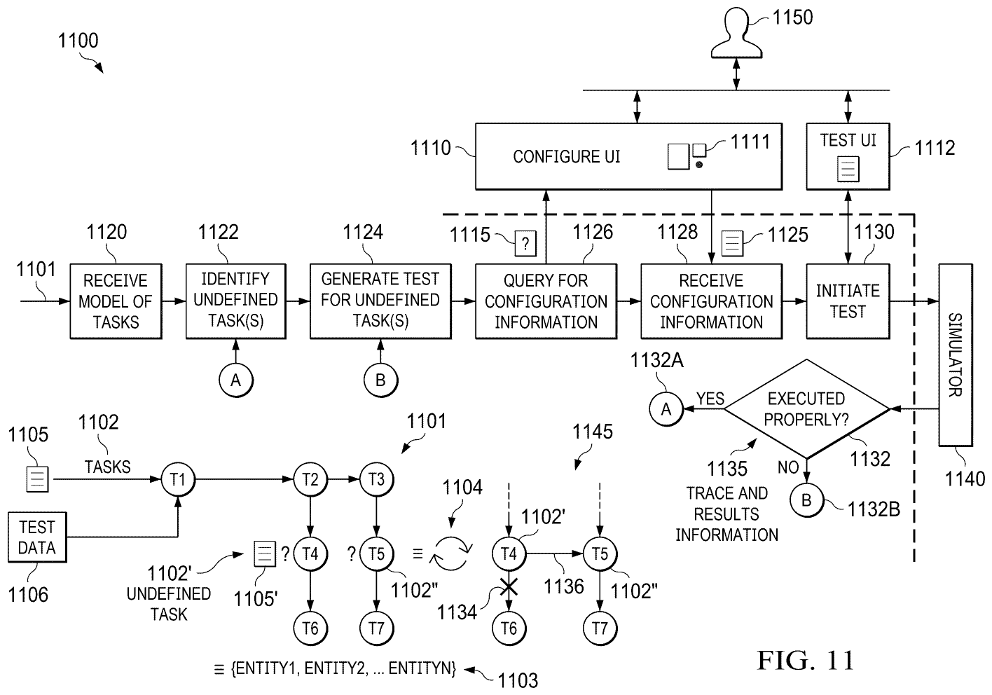

Referring now to FIG. 11, system 1100 (and operations executing thereon comprising 1120, 1122, 1124, 1126, 1128, 1130, 1132) for testing a configuration resulting from a set of tasks 1102 on a transactional system 1104 based on a starter task model 1101 of a set of tasks 1102 received (at 1120). The set of tasks 1102, for illustrative purposes only, are designated in FIG. 11 as tasks T1, T2, T3, T4, T5, T6, T7 occurring between and among entities 1103 (for illustrative purposes only, designated in FIG. 11 as entities ENTITY 1, ENTITY 2, through ENTITY N).

In a non-limiting, real-world example, a workflow is configured by a set of tasks 1102 that contain default configurations for the processing steps for ordering, invoicing, fulfilling, and delivering an order (the “order workflow”). The order workflow occurs between a consumer who initiates the order, a producer who fulfills the order, and a middle-tier actor to facilitate the order and produce a functioning, “transparent” (to the consumer and producer) flow of actions.

As is often the case when an entity needs or desires to interact with other entities, a set of tasks with default configurations may exist that define such an interaction (such as a preexisting set of tasks for the order workflow described above). These existing tasks may leverage pre-existing processing kits that include functionality for the different types of transactions that may need to be executed, such as, but not limited to, a “get value” function, a “set value” function, a “define range” function, etc. Moreover, a set of handlers and/or APIs may exist that predefine such transactions. In some instances, a task may require user input that is context and/or interaction specific.

The entities 1103 transact on the transactional system 1104 to achieve a goal, such as to execute a workflow. The configuration information 1105 is resulted from a test of T1 . . . . T7 from the starter task model. This test may reveal issues/errors/gaps caused by T1 . . . . T7. Thus, the user may need to refine the starter task model, perhaps based on some recommendations from the recommendation engine 640 shown in FIG. 6. In some embodiments, the configuration information 1105 from testing the configuration from the starter task model and the test data 1106 are then used to perform tasks T1, T2, T3, T4, T5, T6, T7, which may involve iteratively testing and refining the configuration of what is being performed.

This is because not all the tasks may be fully defined and configured. Referring again to FIG. 11, as the user performs the tasks, one or more of the tasks 1102′, 1102″ may be undefined and/or incomplete, resulting in configuration information 1105′ (i.e., the configuration information 1105 is modified). Such undefined/incomplete tasks 1102′, 1102″ may comprise, in some embodiments, a skeletal data structure and data functions which need to be expressed and tuned for the overall interaction. In still other embodiments, all is known is that one of the entities requires a piece of formatted information from another entity and/or external source, without which it cannot execute or produces an improper output. As will be described hereinbelow, the test system 1100 advantageously may suggest, recommend, and/or automatically define configuration information 1105′ for such undefined/incomplete tasks 1102′, 1102″.

System 1100 processes a model 1101 of the set of tasks 1102 to identify (at 1122) an undefined/incomplete task 1102′. In a sense, system 1100 possesses knowledge of the set of tasks 1102, the entities 1103, pre-existing configuration information, and background information to execute a workflow. In some embodiments, system 1100 may be aware of the actual entities, tasks, and transactions and context of the workflow and may even automatically “fill in” the needed, desired, and/or required details to execute the workflow (such as the order workflow described above).

Still, system 1100 may not be aware of, define, and/or be capable of configuring every interaction or task. The set of tasks 1102 may in fact comprise an undefined task 1102′ whose execution is undefined with current configuration information 1105. In the example order workflow described above, the producer entity may require a piece of data (such as an order date) to process a new order. The consumer entity however may not have a defined task to provide the piece of data. It may have the piece of data (it may have defined an order date or may have obtained it from an external source) but may have no means to provide the piece of data to the producer entity. As such, the “means to provide the piece of data” is the undefined task 1102′.

System user 1150 may attempt to configure the undefined task 1102′ and test the task with proposed configuration information 1105′. System 1100 may suggest or recommend configuration information to system user 1150, who may then decide to use it with not only the suggested configuration information, but with information that they derive and then test on a simulation of the transactional system. Once the test executes successfully and/or the system user 1150 is satisfied with the results, task 1102′ may then be incorporated into the set of tasks 1102 with configuration information 1105′. System 1100 may then identify any further undefined tasks 1102″ and the process continues until a fully functional workflow is compiled, which may then be deployed with the set of tasks 1102.

System 1100 generates (at 1124) a test for the undefined task 1102′. Here, system 1100 queries (at 1126) for configuration information 1105′ for the undefined task 1102′. In some embodiments, the query may be received at configuration UI 1110 on which system user 1150 can define, copy, paste, etc. configuration information 1105′. In some embodiments, the query includes questions for system user 1150, such as in the order workflow example, a prompt for specific order instructions for a custom order. The query may include pre-existing configuration information, recommendations, and/or background information for the order workflow, and such information may “prefill” fields 1111 on configuration interface 1110 which system user 1150 may accept and/or modify/update.

A portion (or none) of determining configuration information 1125 for undefined task 1102′ may be automated, while another portion requires interaction from system user 1150. Here, to continue with the order workflow example, a producer may require that an order date be provided. It may be that a pre-existing API of the producer includes a function to “set” the order date. System user 1150 may then decide to configure the API set function (using configuration interface 1110) to pass the order date from the consumer to the producer. Alternatively, system user 1150 may import an external avatar (again, using configuration interface 1112) with API functions to pass data back and forth between entities, or a UI may be built and leveraged so that a user can be prompted at run-time for the order date and then can input and submit it. In this way, system 1150 facilitates, once again, the ability to tinker with, self-test, and self-service the compilation of a set of tasks and transactions needed or desired for a workflow between and among transacting entities.

Once configuration information 1125 is determined for the undefined task 1102′, system 1100 receives (at 1128) configuration information 1125 and initiates the test for the undefined task 1102′ for the transactional system 1104, populating and executing the task 1102′ with configuration information 1125. Such received configuration information 1125 may include answers to questions 1115 queried in the previous step.

In some embodiments, the test is initiated at test UI 1112 on which system user 1150 may initiate (at 1130) the test and/or review configuration information 1125 and parameters, with the ability to edit and/or fine tune the information, as well as select test parameters prior to initiating the test. System 1100 may then initiate the test on simulator 1140 for transactional system 1104 (or, in some embodiments on a deployed transaction system), sending configuration information 1125 and test parameters to test simulator 1140. It should be noted that system user 1150 may include multiple users, some of whom may build and design the set of tasks 1102, transactions 1104, entities 1103 and configure undefined tasks 1102′, 1102″, and others of whom may execute tests on the simulator 1140.

Upon completion of the test, system 1100 receives trace 1135 of the test for the undefined task 1102′ to determine (at 1132) whether task 1102′ was successful. Trace 1135 may include, but is not limited to, a record or audit of the tasks and/or subtasks, task data defined and exchanged, a list of functions and routines used in the test or by the task, any errors or task results. The errors or task results may include one or more errors that occurred during the simulation. Such errors may prevent task 1102′ from executing properly and/or may produce errors worth noting but that may not be fatal, such as an inaccurately produced task value or workflow outcome. In some instances, trace 1135 may indicate that some information is still missing and needs to be rectified, which, again facilitates system user 1150 to tinker in an open-ended manner to try different test scenarios and choose an optimal configuration. In this way, trace 1135 helps determine whether the test executed properly and/or in desired manner.

In test scenarios where a test for undefined task 1102′ is determined to not have properly executed (at 1132B), a follow-up test may be generated (once again at 1124), which may comprise querying (at 1126) for new configuration information 1105′ for undefined task 1102′ and receiving (at 1128) new configuration information 1125 for undefined task 1102′. The follow-up test may then be initiated (once again, at 1130), the follow-up test trace 1135 evaluated, and so on. As described above, alternatively, when the test is determined to have properly executed, system 1100 may process the model of the set of tasks 1101 to identify (at 1122) another undefined task 1102″ whose execution is undefined with existing configuration information 1105. In this case, system 1100 generates (at 1124) another test for the next undefined task 1102″, queries and receives configuration information 1125 (at 1126 and 1128) and initiates (at 1130) the test for 1102″ for which trace 1135 may be received and reviewed from simulator 1140.

System 1100 has the flexibility to redesign configuration information 1125 for a previously tested and configured task (which once was task 1102′) based on the results to a subsequent task test (such as task 1102″). The subsequent results may require configuration information 1125 of the previously tested task to be modified (as denoted by reference numeral 1134 in FIG. 11), in which case regeneration and retesting of the previously tested task may be completed. In the example 1145 shown in FIG. 11, a transaction 1134 may be removed and replaced with a new transaction 1136 between task 1102′ and task 1102″.

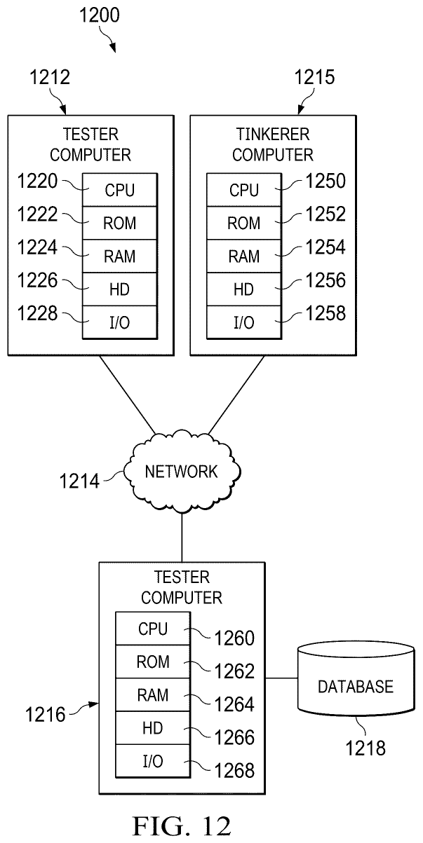

FIG. 12 illustrates an exemplary architecture for network computing environment 1200 that includes network 1214 and computers 1212, 1215, and 1216. Computers 1212, 1215, and 1216 can be bi-directionally coupled to network 1214. Computers 1212, 1215, and 1216 may operate in different computing environments. Computers 1212, 1215, and 1216 may represent computing systems operating in different entities (e.g., an entity A, an entity B, and an integration system). The integration system can be bi-directionally coupled to a database 1218 for storing avatars, task models, rules, handlers, and so on. Network 1214 may represent a combination of wired and wireless networks that network computing environment 1200 may utilize for various types of network communications known to those skilled in the art.

For the purpose of illustration, a single system is shown for each of computers 1212, 1215, and 1216. However, within each computer, a plurality of computers (not shown) may be interconnected to each other over network 1214. For example, a plurality of entity A computers and a plurality of entity B computers 1215 may be coupled to network 1214. Each computer may include a data processing system for communicating with an electronic information exchange platform. In some embodiments, computer 1216 may operate in the computing environment that supports the electronic information exchange platform.

Computer 1212 can include central processing unit (“CPU”) 1220, read-only memory (“ROM”) 1222, random access memory (“RAM”) 1224, hard drive (“HD”) or storage memory 1226, and input/output device(s) (“I/O”) 1228. I/O 1229 can include a keyboard, monitor, printer, electronic pointing device (e.g., mouse, trackball, stylus, etc.), or the like. Computer 1212 can include a desktop computer, a laptop computer, a personal digital assistant, a cellular phone, or nearly any device capable of communicating over a network. Computer 1215 may be similar to computer 1212 and can comprise CPU 1250, ROM 1252, RAM 1254, HD 1256, and I/O 1258.

Likewise, computer 1216 may include CPU 1260, ROM 1262, RAM 1264, HD 1266, and I/O 1268. Computer 1216 may include one or more backend systems configured for providing a variety of services to computers 1212 and 1215 over network 1214. Many other alternative configurations are possible and known to skilled artisans.

Each of the computers shown in FIG. 12 may have more than one CPU, ROM, RAM, HD, I/O, or other hardware components. For the sake of brevity, each computer is illustrated as having one of each of the hardware components, even if more than one is used. Each of computers 1212, 1215, and 1216 is an example of a data processing system. ROM 1222, 1252, and 1262; RAM 1224, 1254, and 1264; HD 1226, 1256, and 1266; and database 1218 can include media that can be read by CPU 1220, 1250, or 1260. Therefore, these types of memories include non-transitory computer-readable storage media. These memories may be internal or external to computers 1212, 1215, or 1216.

Portions of the methods described herein may be implemented in suitable software code that may reside within ROM 1222, 1252, or 1262; RAM 1224, 1254, or 1264; or HD 1226, 1256, or 1266. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a special purpose computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the disclosure should be determined by the following claims and their legal equivalents.

What is claimed is:

1. A computer-implemented method, comprising:
presenting, by an integration system operating on an instance of an electronic information exchange platform in a test mode, processing steps of a workflow to be implemented on the instance of the electronic information exchange platform, the workflow involving entity systems, the processing steps corresponding to tasks specified in a task model, the integration system having an enhanced user interface (UI);
receiving, through the enhanced UI, a scope of the processing steps for testing, wherein one of the processing steps has a dependency on a predecessor in the workflow;
flagging, by the integration system, the dependency without generating an error message;
receiving, through the enhanced UI, an instruction to run a test on the scope of the processing steps;
responsive to failure of the test, determining variations of tasks in the scope and making recommendations based on the variations of tasks in the scope; and
presenting, through the enhanced UI, the recommendations with documentation describing each of the recommendations.

2. The computer-implemented method according to claim 1, wherein the task model is part of a testing framework of the electronic information exchange platform.

3. The computer-implemented method according to claim 1, further comprising:
presenting a configuration of the test through the enhanced UI.

4. The computer-implemented method according to claim 3, further comprising:
receiving a change to the configuration; and
updating a configuration file to reflect the change to the configuration.

5. The computer-implemented method according to claim 4, further comprising:
receiving configurations of tests of the workflow or a portion thereof; and
aggregating the configurations in the configuration file.

6. The computer-implemented method according to claim 5, further comprising:
receiving a confirmation that a system-wide test of the workflow is successful; and
starting to monitor communication between the entity systems in a production mode.

7. The computer-implemented method according to claim 1, wherein a least a portion of the processing steps are performed by avatars of the entity systems, the avatars operated by the integration system.

8. An integration system, comprising:
an enhanced user interface (UI);
a processor;
a non-transitory computer-readable medium; and
Instructions stored on the non-transitory computer-readable medium and translatable by the processor for:
presenting, in a test mode of an instance of an electronic information exchange platform, processing steps of a workflow to be implemented on the instance of the electronic information exchange platform, the workflow involving entity systems, the processing steps corresponding to tasks specified in a task model;
receiving, through the enhanced UI, a scope of the processing steps for testing, wherein one of the processing steps has a dependency on a predecessor in the workflow;
flagging the dependency without generating an error message;
receiving, through the enhanced UI, an instruction to run a test on the scope of the processing steps;
responsive to failure of the test, determining variations of tasks in the scope and making recommendations based on the variations of tasks in the scope; and
presenting, through the enhanced UI, the recommendations with documentation describing each of the recommendations.

9. The integration system of claim 8, wherein the task model is part of a testing framework of the electronic information exchange platform.

10. The integration system of claim 8, wherein the instructions are further translatable by the processor for:
presenting a configuration of the test through the enhanced UI.

11. The integration system of claim 10, wherein the instructions are further translatable by the processor for:
receiving a change to the configuration; and
updating a configuration file to reflect the change to the configuration.

12. The integration system of claim 11, wherein the instructions are further translatable by the processor for:
receiving configurations of tests of the workflow or a portion thereof; and
aggregating the configurations in the configuration file.

13. The integration system of claim 12, wherein the instructions are further translatable by the processor for:
receiving a confirmation that a system-wide test of the workflow is successful; and
starting to monitor communication between the entity systems in a production mode.

14. The integration system of claim 8, wherein a least a portion of the processing steps are performed by avatars of the entity systems, the avatars operated by the integration system.

15. A computer program product comprising a non-transitory computer-readable medium storing instructions translatable by a processor of an integration system for:
presenting, in a test mode of an instance of an electronic information exchange platform, processing steps of a workflow to be implemented on the instance of the electronic information exchange platform, the workflow involving entity systems, the processing steps corresponding to tasks specified in a task model, the integration system having an enhanced user interface (UI);
receiving, through the self-testing user interface, a scope of the processing steps for testing, wherein one of the processing steps has a dependency on a predecessor in the workflow;
flagging the dependency without generating an error message;
receiving, through the enhanced UI, an instruction to run a test on the scope of the processing steps;
responsive to failure of the test, determining variations of tasks in the scope and making recommendations based on the variations of tasks in the scope; and
presenting, through the enhanced UI, the recommendations with documentation describing each of the recommendations.

16. The computer program product of claim 15, wherein the instructions are further translatable by the processor for:
presenting a configuration of the test through the enhanced UI.

17. The computer program product of claim 16, wherein the instructions are further translatable by the processor for:
receiving a change to the configuration; and
updating a configuration file to reflect the change to the configuration.

18. The computer program product of claim 17, wherein the instructions are further translatable by the processor for:
receiving configurations of tests of the workflow or a portion thereof; and
aggregating the configurations in the configuration file.

19. The computer program product of claim 18, wherein the instructions are further translatable by the processor for:
receiving a confirmation that a system-wide test of the workflow is successful; and
starting to monitor communication between the entity systems in a production mode.

20. The computer program product of claim 15, wherein a least a portion of the processing steps are performed by avatars of the entity systems, the avatars operated by the integration system.
